(19) United States
(12) Patent Application Publication
(10) Pub. No.: US 2023/0323996 A1
(43) Pub. Date: Oct. 12, 2023

(54) Instrument and method for inserting a shuttle into a circuit and installation for spraying coating product comprising such an instrument

(71) Applicant: EXEL Industries, EPERNAY (FR)

(72) Inventor: Joseph TARANTINI, EPERNAY (FR)

(21) Appl. No.: 18/193,629

(22) Filed: Mar. 31, 2023

(30) Foreign Application Priority Data
Apr. 6, 2022 (FR) 2203162

(51) Int. Cl. F16L 55/46; B05B 15/50; B08B 9/055

(52) U.S. Cl. CPC F16L 55/46; B05B 15/50; B08B 9/0553; B08B 2209/0556

(57) ABSTRACT

An instrument serves to insert a shuttle into a circuit for circulating a coating product. A chamber for receiving the shuttle, formed in a non-magnetic body is sized for receiving the shuttle in a position where axis of polarization thereof is parallel to a longitudinal axis of the chamber. A mouth connects the chamber to a first end of the body. A control lever equipped with at least two magnets is movable with respect to the chamber between a first position wherein a first magnet is aligned with the longitudinal axis, with a pole oriented towards the chamber having a first polarity, and a second position wherein the second magnet is aligned with the longitudinal axis, with a pole oriented towards the chamber having a second polarity opposite the first polarity.

### REFERENCE TO RELATED APPLICATION

This application is a U.S. non-provisional application claiming the benefit of French Application No. 22 03162, filed on Apr. 6, 2022, the contents of which are incorporated herein by reference in their entirety.

### TECHNICAL FIELD OF THE INVENTION

The present invention relates to an instrument for inserting a shuttle having an axial magnetic polarization into a circuit for circulating a coating product. The present invention further relates to an installation for spraying a coating product comprising such an instrument. Finally, the present invention also relates to a method for inserting a shuttle into a circulating circuit for coating product, by means of such an instrument.

### BACKGROUND OF THE INVENTION

In the field of installations for spraying coating products, it is known, e.g. from WO-A-2021/009046, how to circulate a shuttle, in other words a scraper, inside a pipe belonging to a circuit for circulating a coating product intended to feed a sprayer. An installation according to the prior art is generally satisfactory. In such an installation, the shuttle must be installed into the circuit when the installation is commissioned, then periodically checked and/or changed, especially during maintenance operations. It is thus necessary to insert or reinsert a shuttle into the circuit in a simple way, which usually takes place at a station of the fluid circulation circuit, by disconnecting a hose. The shuttle is magnetically polarized and has positive and negative magnetic poles, intended for interacting with magnetic elements of the installation, in particular for detecting the shuttle within the circuit and/or for interacting with an impulse ejection device, e.g. at a station. It is thus necessary to orient the shuttle in a predetermined way when the shuttle is inserted or reinserted into the circuit.

Such a shuttle has relatively small dimensions, with a length of on the order of 7 millimeters (mm) and a diameter of on the order of 4 mm, which makes the shuttle relatively difficult to handle, especially if the operator is working with gloves. There is thus a risk of making a shuttle fall to the ground, or even of losing same, during the commissioning of the installation or during maintenance operations. Another risk is inserting the shuttle in the wrong polarity direction with respect to the circuit for circulating a coating product, which would lead to a total or partial malfunction of the installation.

It is also known from EP-A-0666448 how to use shuttles with spherical cores, hence without any axial magnetic polarization. It is a delicate matter to control such shuttles.

### SUMMARY OF THE INVENTION

The invention particularly intends to overcome such drawbacks by proposing a new instrument, in other words a new tool for inserting or reinserting into a circuit for circulating a coating product, a shuttle which has an axial magnetic polarization.

To this end, the invention relates to an instrument for inserting a shuttle having an axial magnetic polarization into a circuit for circulating a coating product. According to the invention, the instrument includes:
a chamber for receiving the shuttle, formed in a body of non-magnetic material and sized for receiving the shuttle in a position where an axis of polarization of the shuttle is parallel to a longitudinal axis of the receiving chamber;
a mouth linking the receiving chamber to a first end of the body of the instrument; and
a control lever equipped with at least two magnets, movable with respect to the receiving chamber between a first position in which a first magnet is aligned with the longitudinal axis of the receiving chamber, with a pole oriented towards the receiving chamber having a first polarity, and a second position wherein the second magnet is aligned with the longitudinal axis of the receiving chamber, with a pole oriented towards the receiving chamber having a second polarity, which is the opposite of the first polarity.

By means of to the invention, the chamber for receiving the shuttle, provided in the body of the instrument, may be used for keeping the latter in a predetermined position inside the body, which may be handled by an operator to bring the shuttle close to the shuttle entrance area in a station of the fluid circulation circuit. The operator no longer has to hold the shuttle by hand; the operator may use the instrument for handling the shuttle, in particular for bring the shuttle closer to the station of the fluid circulation. The mouth of the instrument of the invention may be used for guiding the shuttle to the receiving chamber. On the other hand, the first and second magnets which equip the control lever, may be used, for the first of the magnets, to apply a force of attraction on the shuttle and to maintain the position of the shuttle in the receiving chamber with a predetermined axial orientation and, for the second of the magnets, to apply a force so as to eject the shuttle out of the chamber, in the direction of the station of the fluid circulation circuit.

According to advantageous but non-mandatory aspects of the invention, such an instrument may incorporate one or a plurality of the following features, taken individually or according to any technically permissible combination:
The mouth is convergent between the first end of the body and the receiving chamber and configured for guiding the shuttle to the receiving chamber in a position where the axis of polarization thereof is parallel to the longitudinal axis of the receiving chamber.
The two magnets of the control lever are arranged side by side, along a direction perpendicular to the longitudinal axis of the receiving chamber when the control lever is in the first position thereof.
The two permanent magnets of the control lever are mounted on a face of the control lever which is arranged facing the receiving chamber, opposite the mouth with respect to the receiving chamber.
The two magnets of the control lever are flush with the face of the control lever.
The body is equipped with at least one lamp for viewing the contents of the receiving chamber.
The control lever is integral with the body made of non-magnetic material, whereas the control lever is movable, with respect to the receiving chamber and between the first and second positions thereof, by elastic deformation.
The instrument includes, at a second end opposite the first end, a component for extracting the shuttle which is in place in the circuit for circulating a coating product.
The extraction device is a magnetic material element in contact with a pole of the first magnet opposite the pole which is oriented towards the receiving chamber in the first position of the control lever.
The extraction component is arranged inside a tubular portion of the body the external shape of which is configured for shaping one end of a pipe belonging to the fluid circulation circuit.

According to a second aspect, the invention relates to an installation for spraying coating product which includes at least one sprayer fed with coating product, at least one source of coating product, and a circuit for circulating a coating product through which the sprayer of coating product is fed from the source of coating product and where at least one shuttle circulates. According to the invention, such installation includes an instrument as mentioned hereinabove and is arranged for the insertion of the shuttle into the circuit for circulating a coating product, by means of the instrument.

The installation of the invention has substantially the same advantages as the instrument mentioned hereinabove.

According to advantageous but non-mandatory aspects of the invention, such an installation may incorporate one or a plurality of the following features, taken individually or according to any technically permissible combination:
The installation further includes a cannula for inserting the shuttle into the circuit for circulating a coating product, and the internal diameter of the cannula is greater than a maximum diameter of the shuttle and less than an internal diameter of the receiving chamber of the instrument for the insertion of the shuttle into the circuit for circulating a coating product.
The circuit for circulating a coating product includes a circulation pipe for the shuttle and a cannula for inserting the shuttle into the circuit for circulating a coating product, while the cannula and part of the instrument for inserting the shuttle into the circuit for circulating a coating product have the same geometry and while the part of the instrument which has the same geometry as the cannula is configured for shaping one end of the circulation pipe for the shuttle for the mounting thereof on the cannula.
The installation includes a cannula for inserting the shuttle into the circuit for circulating a coating product, while the cannula is made of a material, the Brinell hardness of which is strictly higher than the Brinell hardness of the non-magnetic material of the body of the instrument for the insertion of the shuttle into the circuit for circulating a coating product.

According to a third aspect, the invention relates to a method for inserting, into a circuit for circulating a coating product, a shuttle having an axial magnetic polarization, the method including at least the following operations:
a) bringing close to the shuttle the mouth of an instrument as mentioned hereinabove, the control lever of which in the first position thereof and letting the shuttle penetrate into the receiving chamber of the instrument under the effect of a magnetic attraction exerted by the first magnet thereof aligned with the longitudinal axis of the receiving chamber;
b) arranging the receiving chamber of the instrument opposite an inlet cannula of the circuit for circulating a coating product; and
c) ejecting the shuttle from the receiving chamber into the cannula by moving the control lever of the instrument to the second position thereof, so that the second magnet is aligned with the longitudinal axis of the receiving chamber, to the point that same exerts, on the shuttle, a magnetic repulsion force outside the receiving chamber.

The method of the invention is both simple to implement and reliable, for a safe positioning of the shuttle into the circuit, with a predetermined orientation of the polarized portions thereof.

### BRIEF DESCRIPTION OF THE DRAWINGS

The invention will be better understood and other advantages of the invention will appear more clearly in the light of the following description of an embodiment of an instrument and of an installation for spraying the coating product following the principle thereof, given only as an example and made with reference to the enclosed drawings, wherein:

FIG. 1 is a schematic representation of the principle of an installation for spraying a coating product according to embodiments of the invention, incorporating an instrument according to embodiments of the invention;

FIG. 2 is a perspective view on a larger scale of the instrument of the installation shown in FIG. 1 and of a shuttle shown in three possible spatial positions of the shuttle with respect to the instrument, according to embodiments of the invention;

FIG. 3 is a larger-scale view of detail III of FIG. 2, with a partial pull-off of a front part of the instrument, according to embodiments of the invention;

FIG. 4 is a longitudinal section of the instrument. according to embodiments of the invention;

FIG. 5 shows, on two inserts A) and B) and on a larger scale, detail V of FIG. 4, when the shuttle is in place in the receiving chamber of the instrument, in two positions of use of the instrument, according to embodiments of the invention;

FIG. 6 is a perspective view of the instrument of the invention and of part of the installation shown in FIG. 1 during implementation of a method according to the invention;

FIG. 7 is a perspective view from another angle of a part of the installation, of the shuttle and of the instrument, with partial pull-off of a front part of the instrument, at the end of the method operation shown in FIG. 6, according to embodiments of the invention; and

FIG. 8 is a view similar to FIG. 6 during a use of the instrument, different from same shown in FIG. 6, according to embodiments of the invention.

### DETAILED DESCRIPTION

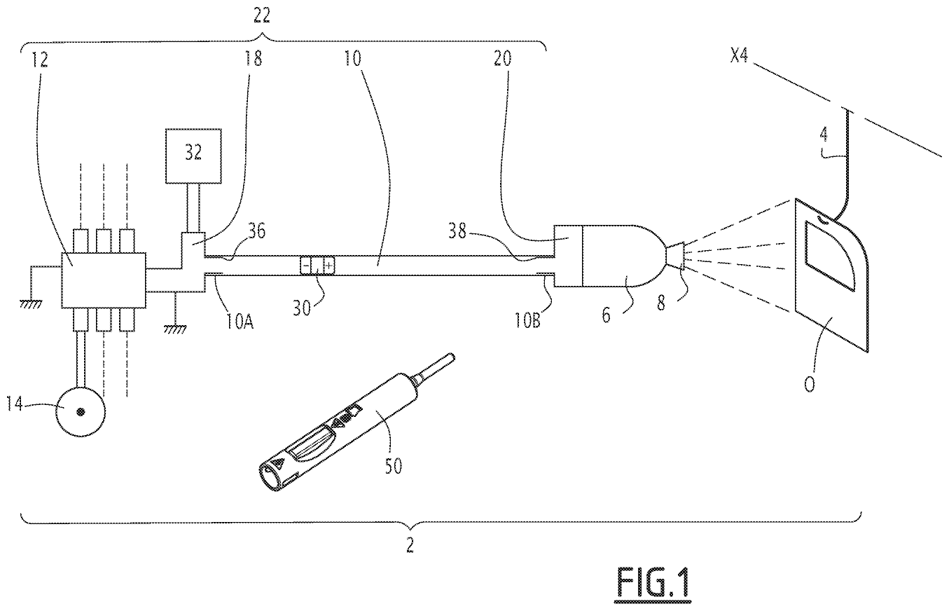

An installation 2, schematically shown in FIG. 1, is intended for applying a coating product over objects O moved by a conveyor 4 along a conveying axis X4. In FIG. 1, objects O are represented in the form of a motor vehicle door. In practice, such objects may consist of all or part of a motor vehicle body and, more generally, of any object to be coated, such as a housing of a household appliance, a cycle frame or an accessory.

Installation 2 includes an electrostatic type, coating product sprayer 6 equipped with a bowl 8 and fed with coating product by means of a pipe 10 wherein circulates, a liquid coating product selected in a color-changing unit 12 connected to several sources 14 of coating product formed by reservoirs, only one of which is shown for simplicity in FIG. 1.

Sprayer 6 may be mounted on the arm of a multi-axis robot or on a reciprocator.

The type of sprayer 6 is not limiting. In a variant, sprayer 6 does not have a bowl. According to another variant, sprayer 6 is not of the electrostatic type. According to yet another variant, sprayer 6 is a manual gun.

In a variant, installation 2 includes a plurality of sprayers such as the sprayer 6 type or of a different type, fed from color-changing unit 12.

Color-changing unit 12 is fluidically connected to a first station 18 to which is connected an upstream end 10A of pipe 10. A downstream end 1013 of pipe 10 is connected to a second station 20, called the end station and integrated into sprayer 6.

Elements 12 to 20 together form a circuit 22 for circulating a liquid coating product between sources 14 and sprayer 6.

Advantageously, at least color changing unit 12 for the coating product and station 18 are brought to earth potential during operation of installation 2.

In order to provide galvanic isolation between sprayer 6, which is brought to high voltage when in operation, and color-changing unit 12 which is continually kept at earth potential, provision is made to circulate a shuttle 30 in pipe 10, by pushing shuttle 30 with a liquid such as a solvent or a cleaning product, between stations 18 and 20, in order to drain the coating product present in pipe 10 and thus to form a sufficient volume for covering the surface of object O. In this way, it is possible to efficiently rinse pipe 10 and sprayer 6 and to limit the losses of coating product.

Shuttle 30 may further be referred to by the term “scraper”.

Pipe 10 is advantageously a hose made of synthetic material, such as polytetrafluoroethylene or PTFE, which has good properties of being able to be rinsed and of a satisfactory coefficient of friction with the shuttle, and [is] installed between stations 18 and 20 in a configuration wherein the pipe has radii of curvature compatible with the displacement of shuttle 30 between ends 10A and 1013 thereof.

The material of pipe 10 bestows a certain elasticity to same, and also an ability to plastically deform when cold, as explained hereinafter.

An electro-pneumatic control module 32 is associated with station 18 and selectively maintains or releases shuttle 30 parked in station 18. To this end, control module 32 includes a pin (not shown) for selectively blocking shuttle 30, as well as a magnetic impulse ejection device (also not shown). When shuttle 30 reaches end station 20 at the end of the motion thereof between ends 10A and 1013 of pipe 10, shuttle 30 is pressed against the bottom of station 20 by the liquid used to push shuttle 30. Return of shuttle 30 towards first station 18 is obtained by applying to shuttle 30, an air pressure coming from sprayer 6.

Stations 18 and 20 are each provided with an internal housing (not shown) forming a garage for receiving shuttle 30. The technical teaching of WO-A-2021/009046 may be applied herein.

Ends 10A and 1013 of pipe 10 are fitted and connected to an outlet cannula 36 of the first station 18 and to an inlet cannula 38 of the second station 20, respectively. X36 denotes a longitudinal and central axis of cannula 36.

Cannula 36 is made of steel, preferentially of grade 303 stainless steel, or of another rigid material, in particular metal. The cannula includes a first end part 361, of convergent frustoconical external shape when moving away from the body of the first station, and a second part 362, of cylindrical external shape with a circular base, which connects the first part to a screw thread 37 of a nut (not shown), used to immobilize end 10A of pipe 10 on cannula 36. The minimum inner diameter of cannula 36 is denoted by D36.

When installation 2 is started, shuttle 30 is inserted into circuit 22 for circulating a coating product by disconnecting end 10A of cannula 36 and by inserting shuttle 30 into station 18, through cannula 36 thereof.

In order to do this, and in accordance with the invention, the operator uses an instrument 50, which may also be called a “tool”, which belongs to installation 2 and which includes a body 52 made of non-magnetic material, e.g. polyamide, in particular such as PA12. Body 52 extends along a longitudinal axis X50 of instrument 50 and defines, at a first longitudinal end 52A of body 52, called the front end, a mouth 54 which converges towards a chamber 56 dimensioned for receiving shuttle 30 with the longitudinal axis X30 thereof superimposed on a longitudinal axis X56 of chamber 56.

Given the materials from which cannula 36 and body 52 are correspondingly made, the material of cannula 36 has a Brinnel hardness strictly greater than the Brinell hardness of the non-magnetic material of body 52. In practice, the Brinnel hardness of the cannula material can be selected with a value close to that of grade 303 stainless steel, at 180 kg/mm², whereas the Brinnel hardness of the material of body 52 may be selected with a value close to the value for a PA12 polyamide, at 8 kg/mm².

By convention, it is considered that the front of instrument 50 is located on the side of front end 52A of body 52 and that the rear of the instrument is located opposite the end.

The longitudinal axes X50 and X56 are herein superimposed. However, the above is not mandatory.

In practice, shuttle 30 has an elongated shape, centered on an axis X30 and a cross-section perpendicular to axis X30, which is circular. Shuttle 30 includes a magnet, in particular a permanent magnet, e.g. a neodymium magnet, not shown. A casing of non-magnetic material of shuttle 30 includes a central portion 302 and two end portions 304 and 306. The magnet of shuttle 30 is embedded in the casing of non-magnetic material, with the negative and positive poles thereof arranged inside portions 304 and 306, respectively. Thereby, shuttle 30 has an axial magnetic polarization, with poles 304 and 306 of opposite polarities located at the two ends thereof. Axis X30 is the polarization axis of shuttle 30. Shuttle 30 is barrel-shaped, with the diameter of end portions 304 and 306 decreasing away from central portion 302, to prevent shuttle 30 from getting stuck in curved areas of pipe 10.

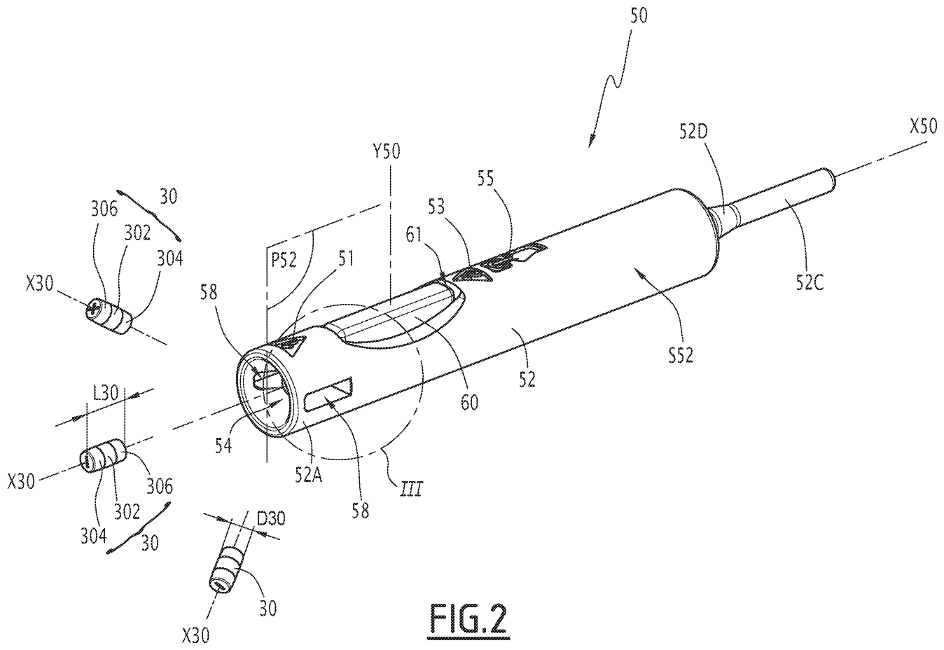

In FIG. 2, shuttle 30 is shown in three possible positions with respect to instrument 50. In practice, shuttle 30 may be arranged in any position with respect to instrument 50.

The internal dimensions of receiving chamber 56 are chosen depending on the length L30 and of the maximum diameter D30 of shuttle 30 so that shuttle 30 may be received in receiving chamber 56 only in a configuration where axes X30 and X56 are merged, within the operating clearance. In particular, inner diameter D56 of receiving chamber 56 is chosen to be greater, within less than 15%, then maximum diameter D30 of shuttle 30.

In practice, the respective dimensions of cannula 36 and of receiving chamber 56 may be chosen depending on maximum diameter D30 of shuttle 30 in such a way that diameter D36 is greater, preferentially strictly greater, than diameter D30 and smaller, preferentially strictly smaller, than inner diameter D56.

For a shuttle with a diameter D30, e.g. equal to 3.85 mm, diameter D36 may be chosen equal to 4 mm and diameter D56 may be chosen equal to 4.5 mm. The manufacturing tolerances on the value of diameter D56 can be on the order of 0.3 mm.

Mouth 54 has a surface S54 which converges towards axis X50 while getting closer to receiving chamber 56. In practice, surface S54 may be chosen to be frustoconical and centered on axis X50.

Surface S54 is configured for guiding shuttle 30 towards receiving chamber 56, towards the position where axes X30 and X56 merge, whatever the position of shuttle 30 at the entrance of mouth 54.

In a variant, receiving chamber 56 may be configured for receiving shuttle 30 in a position wherein axes X30 and X50 are parallel, without being merged.

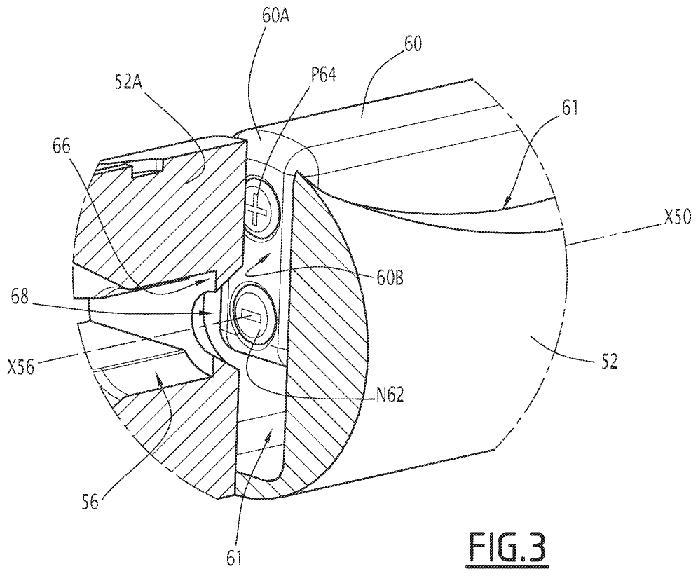

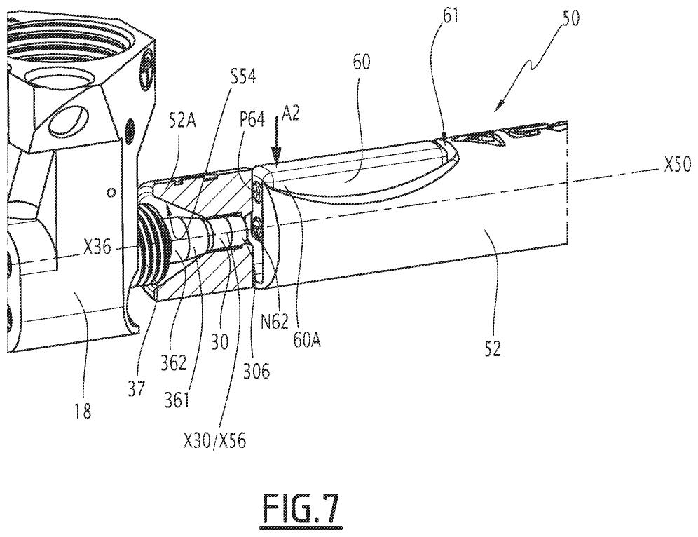

Body 52 is provided with two apertures 58 arranged on both sides of a plane P52 defined by body 52 and containing axis X50. In FIGS. 3 and 7, a part of front end 52A located to the right of plane P52 in FIG. 2 is omitted in order to see mouth 54, chamber 56 and shuttle 30 which is in place in chamber 56.

Receiving chamber 56 may be seen through the two apertures 58 from the outside of body 52, in particular for detecting the presence of shuttle 30 in receiving chamber 56, from one side of instrument 50.

A portion of body 52 defines a control lever 60. In other words, control lever 60 is integral with the rest of body 52.

Control lever 60 is arranged essentially inside a cylindrical casing with a circular cross-section containing an external surface S52 of body 52. Control lever 60 is accessible from the outside of body 52 through a notch 61 which opens onto external surface S52.

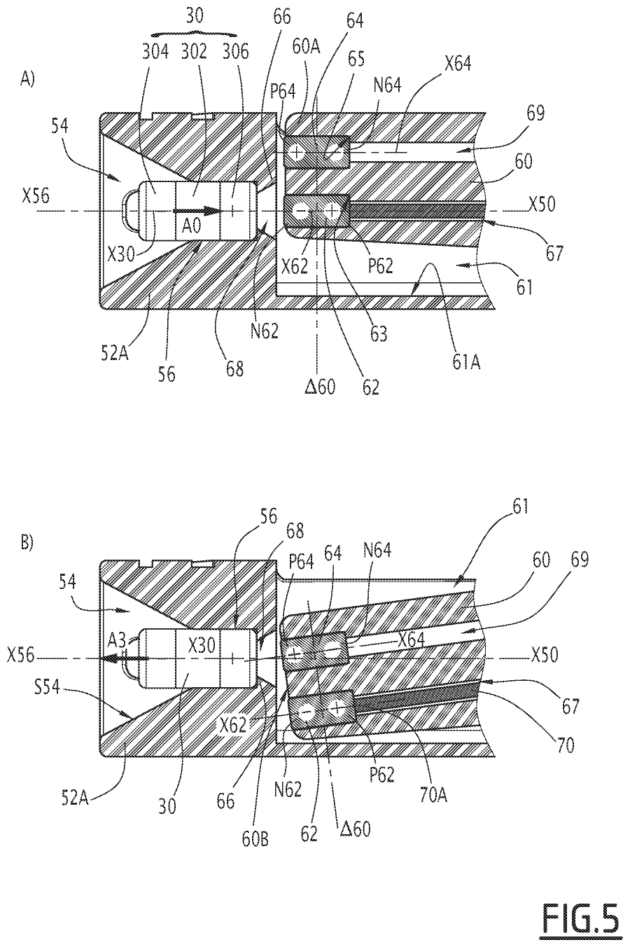

Y50 denotes a transverse axis of instrument 50, perpendicular to axis X50 and running through the center of notch 61. Axes X50 and Y50 are included in a plane P52. Control lever 60 is movable inside notch 61, in a plane parallel to axes X50 and Y50, between a first unstressed position, shown in particular in FIGS. 2-4, 6 and 7, as well as in insert A) of FIG. 5, and a second position, shown in insert B) of FIG. 5, reached when an operator presses on control lever 60, towards the bottom 61A of notch 61. The first position of control lever 60 corresponds to a rest configuration of control lever 60; i.e., a configuration in the absence of any force exerted thereon by an operator.

Control lever 60 defines a first magnet 62 and a second magnet 64. Magnets 62 and 64 are herein permanent magnets, preferentially neodymium magnets.

Permanent magnets 62 and 64 are arranged side by side along a direction A60 parallel to axis Y50 and perpendicular to axis X56, when control lever 60 is in the first position thereof.

Permanent magnets 62 and 64 each extend along respective longitudinal axis X62 and X64, parallel to axis X50 when control lever 60 is in the first position thereof. Axis X64 is parallel to axis X62 but offset laterally with respect to same. Axes X62 and X64 are perpendicular to direction A60. Axes X62 and X64 are parallel to axis X50 when control lever 60 is in the first position thereof.

Magnet 62 has an axial polarization, with a minus pole or negative pole N62 which is oriented, along axis X62, towards mouth 54 and towards receiving chamber 56; i.e., towards the front of instrument 50, and a plus pole or positive pole P62 oriented towards the rear of instrument 50, opposite the mouth and the receiving chamber. Second magnet 64 also has an axial polarity with a plus pole or positive pole P64 oriented towards the front of instrument 50, thus towards mouth 54, and a minus pole or negative pole N64 oriented towards the rear of the instrument, opposite the mouth.

Thereby, permanent magnets 62 and 64 are polarized axially, along respective axes X62 and X64, in opposite directions since the negative pole N62 of first permanent magnet 62 is directed towards the front of instrument 50, whereas the positive pole P64 of second permanent magnet 64 is directed towards the front of instrument 50.

In the first position shown in FIGS. 2-4, 6 and 7, as well as in the insert A) of FIG. 5, control lever 60 holds first magnet 62 in a configuration which is generally aligned with receiving chamber 56. In other terms, in the first position of control lever 60, axes X62 and X56 are generally aligned. “Globally aligned” means that the axes in question are either aligned or parallel, forming an angle of less than 5° therebetween, or offset laterally from each other by a distance of less than 10% of diameter D30.

Herein, axes X62, X56 and X50 are superposed when control lever 60 is in the first position thereof.

As may be seen from FIG. 3, bottom 66 of receiving chamber 56 opposite opening 54 is pierced by an orifice 68 opposite which negative pole N62 of permanent magnet 62 is arranged in the first position of control lever 60.

In such position, permanent magnet 62 emits a magnetic field which propagates, in particular, in receiving chamber 56 and in mouth 54.

First and second permanent magnets 62 and 64 are correspondingly received in first and second housings 63 and 65 provided at end 60A of control lever 60 closest to end 52A of body 52. Housings 63 and 65 open onto an end face 60B of control lever 60 which is perpendicular to axis X50 and parallel to axis Y50 when control lever 60 is in the first position thereof. End face 60B may be called the front face of lever 60 because same is oriented towards the front of instrument 50.

Front face 60B is arranged facing receiving chamber 56, opposite mouth 54. Preferentially, permanent magnets 62 and 64 are flush with front face 60B.

Opposite front face 60B, each of first and second housings 63 and 65 is extended by a respective duct 67 and 69, which opens onto the rear of body 52.

Duct 67 connects housing 63 to a rear end 52B of body 52 opposite front end 52A and which is provided in a tube 52C integral with the rest of body 52 and external diameter D52 of which is strictly smaller than the internal diameter of cannula 36, which allows tube 52C to be engaged into cannula 36, if need be.

A rod 70 made of magnetic material, e.g. steel, is arranged in duct 67 and bears against pole P62 of permanent magnet 62 opposite to the pole which is arranged at front face 60B, namely pole N62. In other terms, rod 70 bears, via a first end 70A, against positive pole P62 of permanent magnet 62. Rod 70 extends to end 52B where the second end 70B thereof, opposite the first end 70A, is located.

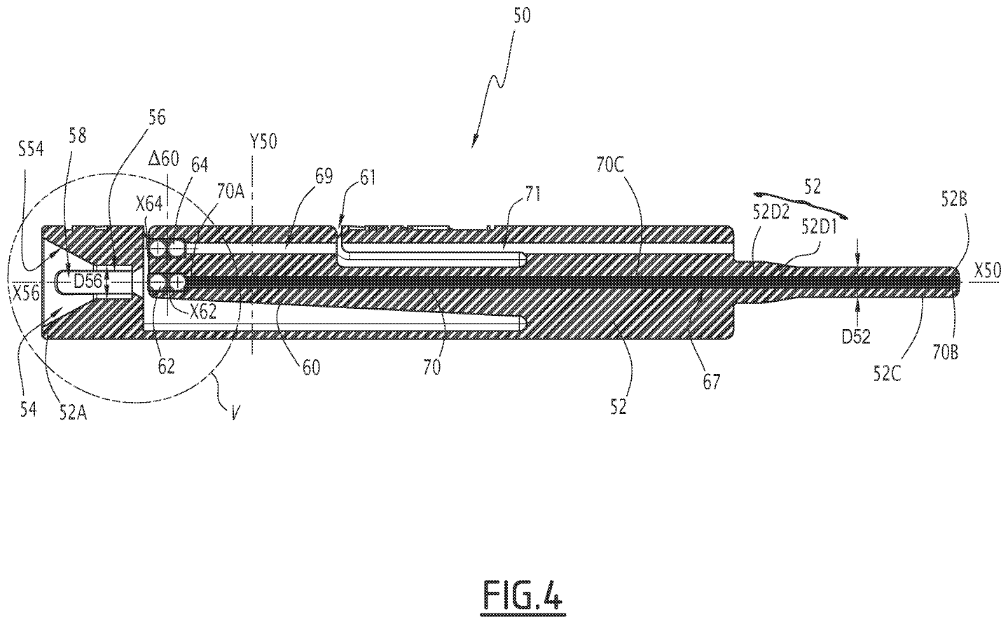

Rod 70 is plastically deformed in an intermediate zone 70C between ends 70A and 70B thereof. Given the scale in FIG. 4, such deformation is not visible. Such localized deformation of rod 70 in zone 70C bestows rod 70 with a geometry which is not perfectly aligned with axis X50, which leads to jamming of rod 70 in duct 67.

Moreover, rod 70, which is made of metal, forms a stiffening element for control lever 60, in the sense that rod 70 tends to return control lever 60 elastically to the first aforementioned position thereof. Thereby, control lever 60 is movable, between the first and second positions thereof and with respect to receiving chamber 56, by elastic deformation of body 52 and of rod 70.

Duct 69 is empty and arranged, when lever 60 is in the first position thereof, in the continuation, along a direction parallel to axis X50, of a duct 71 formed in another part of body 52.

Ducts 69 and 71 may receive a needle with a geometry comparable to the geometry of rod 70, when it is appropriate to extract second permanent magnet 64 from housing 65 thereof by exerting a thrust force on the side thereof defining negative pole N64 thereof and opposite face 60B. The above may be necessary in the event of an error relating to direction of assembly of second permanent magnet 64 during assembly of instrument 50.

In the same way, before rod 70 is installed or after second permanent magnet 64 has been withdrawn, a needle slightly longer than rod 70 may be used to drive first permanent magnet 62 out of housing 63 thereof, in the event of an error relating to the direction of assembly of first permanent magnet 62.

Orifice 68 may be used, during manufacture of instrument 50, for installing permanent magnets 62 and 64 in respective housings 63 and 65, passing through receiving chamber 56.

The instrument operates as explained hereinafter.

When front end 52A of body 52 is brought close to shuttle 30 and when control lever 60 is in the first position thereof, shuttle 30 is attracted by the magnetic field created by first permanent magnet 62, until penetrating mouth 54 and reaching receiving chamber 56 in the position of the insert A) of FIG. 5, where positively polarized portion 306 thereof bears against bottom 66 of receiving chamber 56, under the effect of the magnetic attraction of the negative pole N62 of first permanent magnet 62. Such magnetic attraction is represented by an arrow A0 on the insert A) of FIG. 5.

In other terms, when lever 60 is in the first position thereof, first permanent magnet 62 makes it possible to attract and position shuttle 30 in receiving chamber 56, in a position where axes X30 and X56 are aligned and with a given orientation of polarized portions 304 and 306 thereof along axes. X30 and X56.

Such phenomenon occurs regardless of orientation of portions 304 and 306, and regardless of direction of axis X30 when instrument 50 is brought closer to shuttle 30, which is represented by the three possible positions of shuttle 30 in FIG. 2.

Thereby, the fact of bringing instrument 50 closer to shuttle 30, e.g. when shuttle 30 is held by an operator in the palm of his/her hand, brings shuttle 30 into a given position with respect to body 52 of instrument 50, inside receiving chamber 56. A subsequent handling of shuttle 30 by an operator is in this way facilitated, by means of instrument 50, which is easier to handle than shuttle 30 alone. In other terms, whatever the initial position of shuttle 30, it is sufficient to bring instrument 50 close to shuttle 30, so that shuttle 30 is caught by instrument 50 and guided by surface S54 of mouth 54 towards chamber 56 where shuttle 30 is received and immobilized with a predetermined orientation, due to the action of first permanent magnet 62.

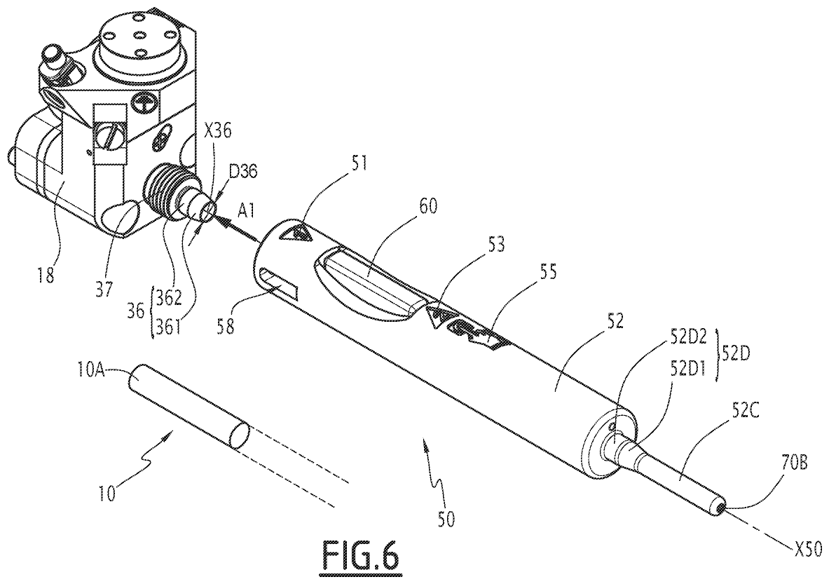

When shuttle 30 has been caught by instrument 50 as explained hereinabove, and after verification of presence of shuttle 30 in receiving chamber 56 by viewing through one of apertures 58, it is possible for the operator who is effectively holding instrument 50 in his/her hand, to align axis X50 with axis X36 and to bring instrument 50 closer to station 18, in an axial translational movement represented by arrow A1 in FIG. 6.

The above has the effect of bringing instrument 50 into the configuration of FIG. 7 where end 52A of body 52 surrounds cannula 36, and where shuttle 30 is arranged at the inlet of cannula 36, the axes X30, X56 and X36 being then aligned.

As can be seen in FIG. 7, the geometry of surface S54 prevents any direct interaction with cannula 36. In other words, the centering of shuttle 30 on cannula 36 is not hampered by an untimely contact between instrument 50 and station 18.

In such configuration, the operator exerts on end 60A of lever 60, a force represented by arrow A2 in FIG. 7 and perpendicular to longitudinal axis X50. In practice, such force is parallel to axis Y50 and to direction A60. The force has the effect of bringing control lever 60 into the second position thereof, as shown in the insert B) of FIG. 5, where second permanent magnet 64 is opposite orifice 68 and of positively polarized portion 306 of shuttle 30. Since the pole of magnet 64 exposed on front face 60B is plus pole P64 of second permanent magnet 64, the bringing closer of second permanent magnet 64 and of shuttle 30 has the effect of exerting a magnetic repulsion force on shuttle 30, i.e., an ejection force of shuttle 30 towards the outside of chamber 56, represented by arrow A3 on the insert B) in FIG. 5. Such magnetic repulsion force drives shuttle 30 away from bottom 66 and along axis X56, i.e., towards the inside of cannula 36, along axis X36.

Thus, shuttle 30 is injected into station 18, through cannula 36, with a predetermined orientation, which is the direct consequence of the orientation thereof within receiving chamber 56 following catching thereof by instrument 50.

Arrows A0 and A3 are aligned with axis X56, which is oriented in two opposite directions, towards bottom 66 and away from bottom 66, respectively.

Instrument 50 is thus effective for catching shuttle 30 and for inserting shuttle 30 into circuit 22, with a given orientation.

The above allows shuttle 30 to circulate in pipe 10 while maintaining the orientation which is useful for interacting with other magnetic elements integrated in stations 18 and 20.

The ejection of shuttle 30 towards the inside of station 18 takes place by a simple pressure of the operator on control lever 60 once instrument 50 has been correctly positioned with respect to cannula 36. Apertures 58 allow the operator to see such ejection and to check that the desired operation has indeed taken place.

Handling of instrument 50 is thus particularly simple and essentially includes three operations.

In a first operation, explained by a pictogram 51 provided on body 52, the operator brings mouth 54 closer to shuttle 30, which can be in one of the positions shown in FIG. 2 or in another position, and allows shuttle 30 to penetrate as far as receiving chamber 56 under action of first permanent magnet 62 which is then aligned on longitudinal axis X56. Shuttle 30 is automatically positioned correctly for the rest of the operations.

In a second operation, the operator moves receiving chamber 56 closer to station 18, following direction of arrow A1 in FIG. 6, until receiving chamber 56 is positioned facing cannula 36, which is represented by a second pictogram 53 affixed to body 52.

In a third operation, the operator exerts the force represented by arrow A2, which corresponds to a third pictogram 55. Control lever 60 is thereby brought into the second position thereof, and thus second permanent magnet 64 in alignment with longitudinal axis X56 of chamber 56, which has the effect of ejecting shuttle 30 in the direction of arrow A3, by magnetic repulsion between positively polarized portion 306 and positive pole P64 of second permanent magnet 64 which is arranged at front face 60B of control lever 60.

When shuttle 60 is in place in station 18, tube 52C may be used as a template for shaping end 10A of tube 10 to the external dimensions of cannula 36. To this end, a junction zone between tube 52C and the main part of body 52 includes a bulge 52D which progressively increases the diameter of tube 52C by getting closer to the main part. Such bulge is a scale 1 image of the external shape of cannula 36 and includes a frustoconical part 52D1 of external shape identical to the shape of first end part 361 of cannula 36, and a cylindrical part with circular base 52D2 with external shape identical to the shape of second part 362 of cannula 36. Thereby, by inserting tube 52C into pipe 10 by end 10A thereof, until being covered by bulge 52D, it is possible to expand end 10A and shape the end, by plastic deformation, with an inner shape close to the outer shape of cannula 36, which facilitates the subsequent positioning of end 10A around cannula 36.

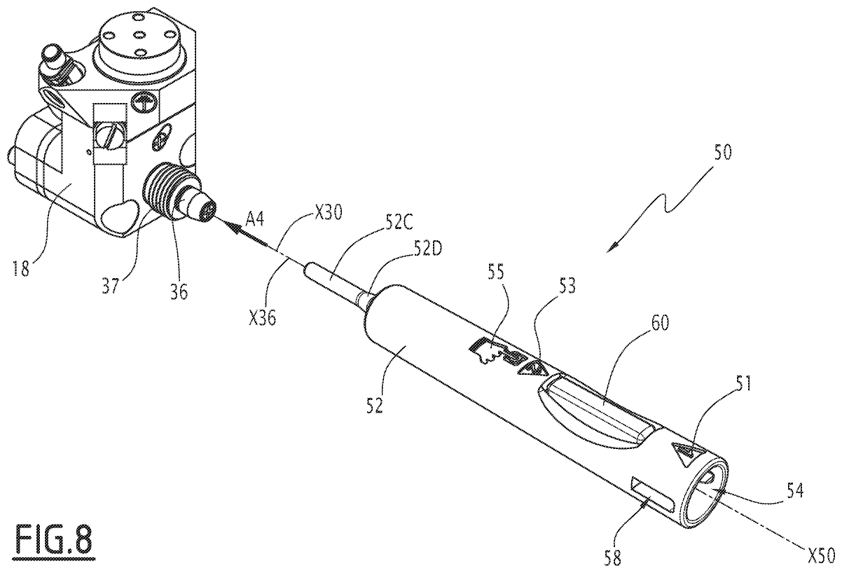

When it is necessary to recover shuttle 30 which is in place in station 18, instrument 50 is used in the opposite direction to the direction shown in FIG. 6, as shown in FIG. 8.

In such case, positively polarized portion 306 of shuttle 30 is either flush with the free end of cannula 36, or accessible through cannula 36.

It is then possible, after having aligned axis X50 with axis X36, to bring tube 52C closer to cannula 36 as represented by arrow A4 in FIG. 8.

Since end 70B of rod 70 is made of a magnetic material, end 70B is magnetized to some extent by polarized portion 306. Thereby, a magnetic attraction force is exerted between parts 70B and 306, which makes it possible to extract shuttle 30 from station 18 by exerting an axial traction force on instrument 50, in a direction opposite to the aforementioned approach movement represented by the arrow A4.

Thereby, second end 70B of rod 70 forms a component for extracting shuttle 30 which is in place in circuit 22 for circulating a coating product, outwards from circuit 22. The instrument of the invention thus may be used not only to insert shuttle 30 into circuit 22 but also to withdraw shuttle 30 from circuit 22, when necessary, e.g. for a maintenance operation.

In a variant, magnets 62 and 64 are electromagnets. In such case, instrument 50 includes means for activating the electromagnets. Such approach is less economical and more prone to failure than the approach based on permanent magnets.

In a variant, polarities of first and second permanent magnets 62 and 64 are reversed with respect to polarities shown in the figures. In such case, shuttle 30 is inserted into cannula 36 in the opposite direction to the direction shown in the figures.

According to another variant, insertion of shuttle 30 into circuit 22 takes place at second station 20.

According to yet another variant, control lever 60 includes more than two magnets, whether permanent or not.

According to another variant, control lever 60 includes a piece added onto body 52, without being integral with body 52.

The aforementioned variants can be combined to generate new embodiments within the framework of the invention.

1. An instrument for inserting a shuttle having an axial magnetic polarization into a circuit for circulating a coating product, the instrument comprising:
a receiving chamber for receiving the shuttle, the chamber being formed in a body of non-magnetic material and sized for receiving the shuttle in a position where an axis of polarization of the shuttle is parallel to a longitudinal axis of the receiving chamber;
a mouth connecting said receiving chamber to a first end of the body of the instrument;
a control lever, equipped with at least two magnets and movable with respect to said receiving chamber, between a first position, where a first magnet is aligned with the longitudinal axis of said receiving chamber, with a pole oriented towards said receiving chamber having a first polarity, and a second position, where the second magnet is aligned with the longitudinal axis of said receiving chamber, with a pole oriented towards said receiving chamber having a second polarity, which is the opposite of the first polarity.

2. The instrument according to claim 1, wherein said mouth is convergent between the first end of the body and said receiving chamber, and configured for guiding the shuttle towards said receiving chamber in a position where the polarization axis thereof is parallel to the longitudinal axis of said receiving chamber.

3. The instrument according to claim 1, wherein the two magnets of said control lever are arranged side by side along a direction perpendicular to the longitudinal axis of said receiving chamber when said control lever is in the first position thereof.

4. The instrument according to claim 1, wherein the two permanent magnets of said control lever are mounted on a face of said control lever facing said receiving chamber, opposite said mouth with respect to said receiving chamber.

5. The instrument according to claim 4, wherein the two magnets of said control lever are flush with the face of said control lever.

6. The instrument according to claim 1, wherein the body is equipped with at least one aperture for viewing the contents of said receiving chamber.

7. The instrument according to claim 1, wherein said control lever is integral with the body made of non-magnetic material and wherein said control lever is movable with respect to said receiving chamber, between the first and the second positions thereof, by elastic deformation.

8. The instrument according to claim 1, further comprising, at a second end opposite the first end, an extraction component for extracting the shuttle which is in place in the circuit for circulating a coating product to the outside.

9. The instrument according to claim 8, wherein said extraction component is an element of magnetic material in contact with a pole of the first magnet opposite the pole, which is oriented towards said receiving chamber in the first position of said control lever.

10. The instrument according to claim 8, wherein said extraction component is arranged inside a tubular portion of the body, the external shape of which is configured for shaping one end of a pipe belonging to the circuit for circulating a coating product.

11. An installation for spraying a coating product, the installation comprising:
an instrument according to claim 1, wherein the installation inserts a shuttle into a circuit for circulating the coating product by means of the instrument;
at least one sprayer for the coating product;
at least one source of the coating product; and
the circuit for circulating the coating product, by means of which said at least one sprayer of the coating product is fed from said at least one source of the coating product, and wherein the shuttle circulates.

12. The installation according to claim 11, further comprising a cannula for inserting the shuttle into the circuit for circulating a coating product, and wherein an inner diameter of said cannula is greater than a maximum diameter of the shuttle and less than an internal diameter of the receiving chamber of said instrument.

13. The installation according to claim 11, wherein said circuit for circulating a coating product comprises:
a circulation pipe for the shuttle; and
a cannula for inserting the shuttle into said circuit for circulating a coating product, wherein said cannula and a part of said instrument have the same geometry, and wherein the part of said instrument which has the same geometry as said cannula is configured for shaping one end of said circulation pipe for the shuttle for the mounting thereof on said cannula.

14. The installation according to claim 11, further comprising a cannula for inserting the shuttle into said circuit for circulating the coating product, wherein said cannula is comprised of a material the Brinell hardness of which is strictly greater than the Brinell hardness of the non-magnetic material of the body of said instrument.

15. A method for inserting a shuttle having an axial magnetic polarization into a circuit for circulating a coating product, wherein said method comprises:
bringing close to the shuttle, the mouth of an instrument according to claim 1, the control lever of the instrument being in the first position, and allowing the shuttle to enter the receiving chamber of the instrument under the effect of a magnetic attraction exerted by the first magnet thereof aligned with the longitudinal axis of the receiving chamber;
arranging the receiving chamber opposite an inlet cannula of the circuit for circulating a coating product; and
ejecting the shuttle from the receiving chamber into the cannula by moving the control lever of the instrument into the second position thereof, so that the second magnet is aligned with the longitudinal axis of the receiving chamber, to the point that the second magnet exerts, on the shuttle, a magnetic repulsion force outside the receiving chamber.
